(19) United States
(12) Patent Application Publication
(10) Pub. No.: US 2010/0141990 A1
(43) Pub. Date: Jun. 10, 2010

(54) IMAGE PROCESSING APPARATUS AND IMAGE PROCESSING SYSTEM

(75) Inventor: Akihiro YAMADA, Nagoya-shi (JP)

Correspondence Address: Scully, Scott, Murphy & Presser, P.C., 400 Garden City Plaza, Suite 300, Garden City, NY, 11530, US

(73) Assignee: BROTHER KOGYO KABUSHIKI KAISHA, Aichi-ken (JP)

(21) Appl. No.: 12/634,172

(22) Filed: Dec. 9, 2009

(30) Foreign Application Priority Data
Dec. 9, 2008 (JP) 2008-313024

(51) Int. Cl. G06F 15/00; H04N 1/40

(52) U.S. Cl. 358/1.15; 358/448

(57) ABSTRACT

An image processing apparatus includes: an execution unit that executes a processing request accepted by an acceptance unit and stored in a storage unit; a setting unit which, when the processing request is accepted, sets the stored processing request as a queued processing request if another processing request is executed, and which sets the stored processing request as a permitted processing request if no processing request is executed; a notification unit that notifies a current user that there exists a queued processing request; an instruction unit which, when instructed by the current user, instructs whether or not to permit execution of the queued processing request; and an interrupt control unit which, when the current user instructs to permit the execution of the queued processing request through the instruction unit, controls the execution unit to interrupt the execution of the permitted processing request and execute the instructed queued processing request.

This application claims priority from Japanese Patent Application No. 2008-313024 filed on Dec. 9, 2008, the entire subject matter of which is incorporated herein by reference.

### TECHNICAL FIELD

The invention relates to an image processing apparatus that enables a user, who outputs a processing request that is currently being executed by the image processing apparatus, to control the image processing apparatus to interrupt execution of the processing request from the user and allow another processing request, which is of another user and is queued, to be executed. The invention also relates to an image processing system using the image processing apparatus.

### BACKGROUND

There has been proposed an image processing apparatus, in which one image processing apparatus is connected to a plurality of personal computers (PCs) through a network and is shared among the plurality of PCs. When a plurality of users output processing requests of copy, PC print, etc., the image processing apparatus executes a processing request of a user who outputs the processing request first. In such an image processing apparatus, usually, unexecuted processing requests of other users are queued in the image processing apparatus. After execution of the processing request of the user, who outputs the processing request first, is completed, the queued processing request is then executed.

Thus, even if the queued processing request output by another user is an urgent processing request, the urgent processing request is not executed until the execution of the processing request of the user, who outputs the processing request earlier, is completed.

In order to solve the problems, there has been proposed an art relating to a facsimile server including a confidential print function. The facsimile server allows the processing request of one user currently being executed to be interrupted so as to execute a processing request of another user when another user enters a password on the facsimile server.

### SUMMARY

Illustrative aspects of the invention provide an image processing apparatus which, upon receiving an instruction from a user whose processing request is currently being executed by the image processing apparatus for interrupting execution of the processing request of the user, interrupts the execution of the processing request of the user and executes a queued processing request. Illustrative aspects of the invention also provide an image processing system using the image processing apparatus.

### BRIEF DESCRIPTION OF THE DRAWINGS

In the accompanying drawings:

FIG. 1 is a block diagram to show an example of an image processing system including an MFP and PCs according to an exemplary embodiment of the invention;

FIG. 2 is a block diagram of the image processing system;

FIG. 3 is an external view of the MFP;

FIG. 4 is a flowchart relating to a transmission processing of a processing request from the PC to the MFP;

FIG. 5 shows an example of a processing request setting screen;

FIG. 6 shows an example of a PJL command;

FIG. 7 is a flowchart relating to creating the processing request by the MFP;

FIG. 8 is a flowchart relating to a processing request acceptance processing in the MFP;

FIG. 9 shows an example of a management table according to a first example;

FIG. 10 is a flowchart relating to a processing request execution processing in the MFP;

FIG. 11 is a flowchart relating to a condition setting processing for determining whether or not to provide a notification that a queued processing request exists;

FIG. 12 shows an example of a condition setting screen;

FIG. 13 is a flowchart relating to a notification processing sent to the PC or the MFP outputting a permitted processing request;

FIG. 14 is a flowchart relating to instruction processing of an interrupt processing request in the PC receiving notification that the queued processing request exists;

FIG. 15 shows an example of a setting screen to show that the queued processing request exists;

FIG. 16 shows an example of a setting screen;

FIG. 17 shows an example of a management table according to a second example;

FIG. 18 is a flowchart relating to instruction processing of an interrupt processing request in the MFP receiving the notification that the queued processing request exists;

FIG. 19 shows an example of a second display unit of the PC to display a message indicating that the queued processing request exists;

FIG. 20 shows an example of an authentication setting screen displayed on a first display unit of the MFP;

FIG. 21 shows an example of display of the contents related to the queued processing request on the first display unit;

FIG. 22 shows the management table updated in the second example;

FIG. 23 shows an example of a message as to whether or not to select another processing request displayed on the first display unit;

FIG. 24 shows the management table updated in the second example;

FIG. 25 is a flowchart relating to an interrupt processing;

FIG. 26 shows an example of management table update at the time of interrupt processing in the first example;

FIG. 27 shows an example of management table update at the time of interrupt processing in the second example;

FIG. 28 shows an example of management table update at the time of interrupt processing in the second example;

FIG. 29 shows an example of management table update at the time of executing the interrupted processing request in the first example; and

FIG. 30 shows an example of management table update at the time of executing the interrupted processing request in the second example.

### DETAILED DESCRIPTION

### General Overview

In the related art facsimile server, another user can interrupt the processing request of one user currently being executed and execute another processing request prior to the processing request of the one user. However, if the processing request of the one user is interrupted, the one user may be offended.

Therefore, illustrative aspects of the invention provide an image processing apparatus which, upon receiving an instruction from a user, whose processing request is currently being executed by the image processing apparatus, for interrupting execution of the processing request of the user, interrupts the execution of the processing request of the user and executes a queued processing request. Illustrative aspects of the invention also provide an image processing system using the image processing apparatus.

According to a first illustrative aspect of the invention, there is provided an image processing apparatus comprising: an acceptance unit that accepts a processing request output from a user; a storage unit that stores the processing request accepted by the acceptance unit; an execution unit that executes the processing request stored in the storage unit; a setting unit which, when the processing request is accepted by the acceptance unit, is configured to: set the processing request stored in the storage unit as a queued processing request if another processing request is executed using the execution unit; and set the processing request stored in the storage unit as a permitted processing request if no processing request is executed using the execution unit; a notification unit that notifies a user who outputs the permitted processing request set in the setting unit that there exists a queued processing request set in the setting unit; an instruction unit which, when instructed by the user whose permitted processing request is being executed based on the notification from the notification unit, instructs whether or not to permit execution of the queued processing request; and an interrupt control unit which, when the user whose permitted processing request is being executed instructs to permit the execution of the queued processing request through the instruction unit, controls the execution unit to interrupt the execution of the permitted processing request and execute the instructed queued processing request.

According to the image processing apparatus of the invention, the user, who controls the image processing apparatus to execute a processing request (PC print, PC FAX, copy, etc.,), can control the image forming apparatus to execute another queued processing request. Thus, according to the determination of the user who currently using the image processing apparatus, it is possible for the another user to use the image processing apparatus.

According to a second illustrative aspect of the invention, the image processing apparatus further comprises: a request content storage unit that stores the contents related to the queued processing request; and a first display unit that displays the contents stored in the request content storage unit based on the notification provided by the notification unit, wherein the instruction unit instructs the instruction from the user whose permitted processing request is being execute whether or not to permit the execution of the queued processing request based on the contents displayed on the first display unit.

That is, the contents related to the queued processing request are displayed on the display unit of the image processing apparatus. Thus, referring the queued processing request displayed on the display, the user can appropriately instruct whether or not to permit execution of the queued processing request.

According to a third illustrative aspect of the invention, in the image processing apparatus, wherein the instruction unit selects a plurality of queued processing requests from among the queued processing requests displayed on the first display unit and instructs permission of execution of the selected queued processing requests.

That is, the number of queued processing requests instructed by the instruction unit is not limited to one, and a plurality of queued processing requests may exist. The instruction unit instructs the plurality of queued processing requests. The user can select the plurality of queued processing requests in response to the situation of the queued processing requests.

According to a fourth illustrative aspect of the invention, the image processing apparatus further comprises: a display selection unit that selects whether or not to display the contents stored in the request content storage unit on the first display unit when the notification unit notifies that the queued processing request exists, wherein, when selected by the display selection unit, the first display unit displays the contents stored in the request content storage unit.

That is, when the queued processing request exists, the user can select whether or not to display the contents of the queued processing request on the display unit. If the user allows the queued processing request to be executed, the user can display the contents of the queued processing request on the display unit and can determine whether or not to execute the queued processing request based on the display. If the user does not want to interrupt his or her processing request to execute the queued processing request, the user can continue processing of the processing request currently being executed without displaying the contents of the queued processing request on the display unit.

According to a fifth illustrative aspect of the invention, the image processing apparatus further comprises: a condition setting unit that sets a condition whether nor not to notify the contents related to the queued processing request, the contents including at least one of name of the user, type of the processing request, information concerning the data amount, processing time relating to the processing request and information indicating urgency of the processing request; and a determination unit that determines whether or not the contents stored in the request content storage unit match the condition set in the condition setting unit, wherein, if the determination unit determines that the contents stored in the request content storage unit match the condition set in the condition setting unit, the notification unit notifies that there exists the queued processing request matching the condition set in the condition setting unit.

That is, the image processing apparatus of the invention determines whether or not to provide notification if a processing request corresponding to the condition exists based on the setup condition. For example, the condition is information indicating the number of pages, the estimated processing time, and urgency of the processing request, the information concerning the queued processing request. By notifying a fact that the queued processing request matching the condition exists while a fact that the queued processing request not matching the condition exists is not notified, usability can be improved.

According to a sixth illustrative aspect of the invention, the image processing apparatus further comprises: a continuation execution unit that controls the execution unit to execute the interrupted processing request after completion of execution of the queued processing request instructed by the interrupt control unit.

That is, in the image processing apparatus of the invention, the interrupt control unit interrupts execution of the permitted processing request. After completion of execution of the instructed queued processing request, the continuation execution unit controls the execution section so as to execute the interrupted permitted processing request, so that processing of the interrupted permitted processing request can be executed efficiently.

According to a seventh illustrative aspect of the invention, there is provided an image processing system comprising an information processing apparatus for transmitting a processing request and an image processing apparatus for executing the processing request, wherein the image processing apparatus comprises: an acceptance unit that accepts the processing request transmitted from the information processing apparatus; a storage unit that stores the processing request accepted by the acceptance unit; an execution unit that executes the processing request stored in the storage unit; a setting unit that is configured to: set the processing request stored in the storage unit as a queued processing request if another processing request is executed using the execution unit when the processing request is accepted by the acceptance unit; and set the processing request stored in the storage unit as a permitted processing request if no processing request is executed using the execution unit; and a notification unit that notifies the information processing apparatus that transmits the permitted processing request set in the setting unit that there exists a queued processing request set in the setting unit, wherein the information processing apparatus comprises: a second reception unit that receives the notification from the notification unit; a second display unit that displays the notification received by the second reception unit; an instruction unit that instructs whether or not to permit execution of the queued processing request based on the notification displayed on the second display unit; and a transmission unit that transmits information indicating existence of the queued processing request instructed by the instruction unit to the image processing apparatus, and wherein the image processing apparatus further comprises: a first reception unit that receives the information of existence of the instructed queued processing request transmitted by the transmission unit; and an interrupt control unit which, when the first reception unit receives the information of existence of the instructed queued processing request, controls the execution unit to interrupt the execution of the permitted processing request and execute the instructed queued processing request.

That is, in the image processing system of the invention including the information processing apparatus for transmitting a processing request and the image processing apparatus for executing the processing request, the notification unit of the image processing apparatus notifies the information processing apparatus executing the processing request that the queued processing request exists. The contents of the notification are displayed is displayed on the second display unit of the information processing apparatus transmitting the executed permitted processing request. The information processing apparatus can instruct execution of the queued processing request.

Incidentally, the instruction section and the display selection section may be included not only in the image processing apparatus, but also in the information processing apparatus.

According to an eight aspect of the invention, there is provided a multi-function device comprising: an image forming unit that forms an image; a scanner unit that reads the image; a facsimile transmission unit that transmits/receives facsimile data; a remote communication unit that is connected to a network; an input unit that receives input; a display unit; a control unit, which is connected to the image forming unit, the scanner unit, the facsimile transmission unit, a remote communication unit, the input unit and the display unit, and which processes a job, wherein, when the control unit receives a second job through the remote communication unit while the control unit is processing a first job by using one of the image forming unit, the scanner unit and the facsimile unit, the control unit is configured to: control the display unit to display information indicating receipt of the second job; and if the input unit receives input, in accordance with the input, execute either one of: (a) continuing processing the first job while holding processing the second job; or (b) suspending processing the first job and processing the second job; and if the input unit does not receive the input, process the first job and the second job in accordance with a received order.

According to a ninth aspect of the invention, there is provided a method for controlling a multi-function device, the multi-function device comprising: an image forming unit that forms an image; a scanner unit that reads the image; a facsimile transmission unit that transmits/receives facsimile data; a remote communication unit that is connected to a network; an input unit that receives input; a display unit; a control unit, which is connected to the image forming unit, the scanner unit, the facsimile transmission unit, a remote communication unit, the input unit and the display unit, and which processes a job, wherein the method comprises: control the display unit to display information indicating receipt of the second job; and if the input unit receives input, in accordance with the input, execute either one of: (a) continuing processing the first job while holding processing the second job; or (b) suspending processing the first job and processing the second job; and if the input unit does not receive the input, process the first job and the second job in accordance with a received order.

The invention provides an image processing apparatus for enabling the user executing a processing request using the image processing apparatus to interrupt the processing request and allow the queued processing request to be executed.

### EXEMPLARY EMBODIMENTS

Exemplary embodiments of the invention will now be described with reference to the drawings. Incidentally, in an image processing system, personal computers (PCs) and a multi-function device (MFP) of an image processing apparatus are connected to a network.

(Image Processing System)

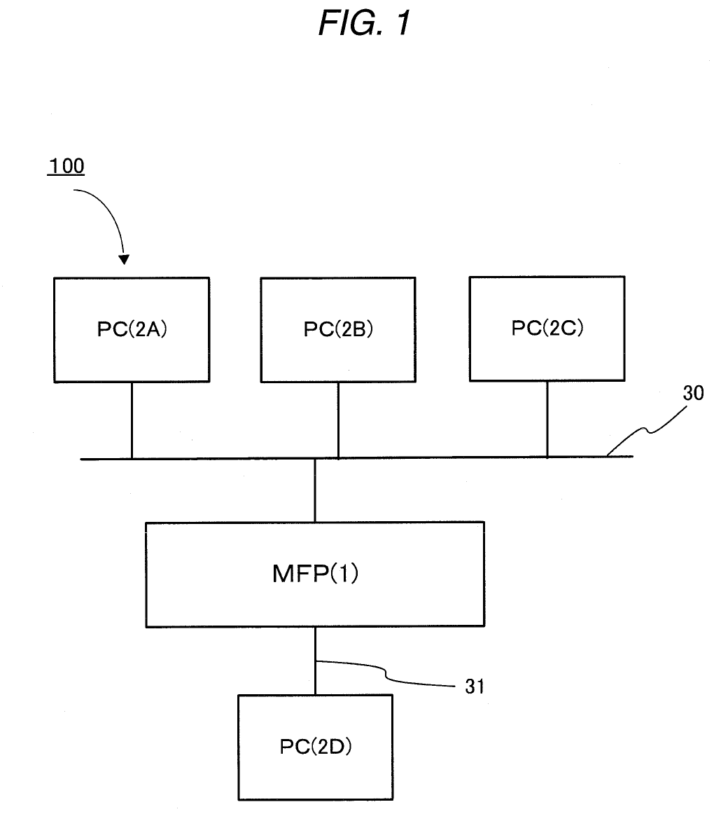

In an image processing system 100 of the exemplary embodiment shown in FIG. 1, an MFP 1 and PCs 2A to 2C are connected through a network 30 of a LAN, etc., or the MFP 1 and a PC 2D are connected directly through a USB cable 31. Any number of MFPs and PCs making up the image processing system 100 may be connected. In the following description, each PC is called PC 2 where the PCs need not be distinguished from each other.

In the image processing system 100, a processing request is output to the MFP 1 from each of the PCs 2A to 2D. In the MFP 1, the user can execute a processing request of PC print, PC scan, PC FAX transmission, etc., through the PC 2. The user can also execute a processing request of copy, scan, FAX transmission, etc., directly from MFP 1 not via the PC 2.

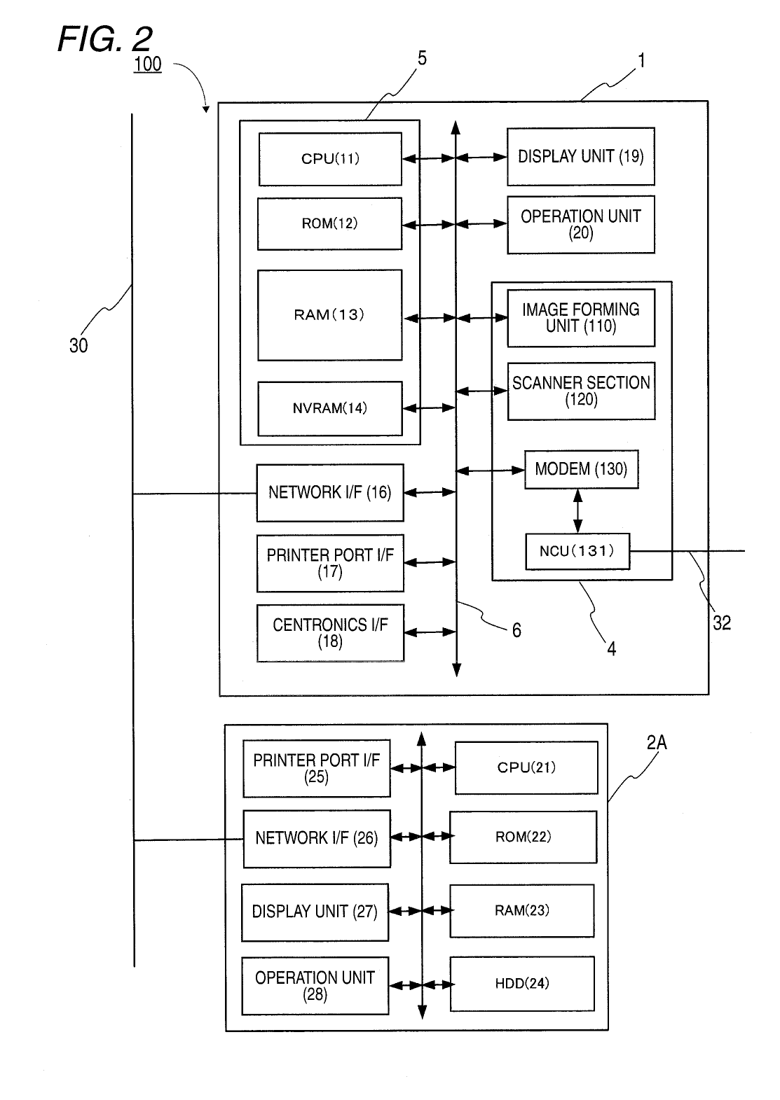

FIG. 2 shows a relationship between the MFP 1 and the PC 2A. Incidentally, PCs 2B, 2C and 2D are omitted in FIG. 2.

As shown in FIG. 2, the MFP 1, which forms a part of the image processing system 100, includes: a control unit 5 including a CPU 11 (one example of an acceptance unit, a notification unit, an interrupt control unit, a continuation execution unit, a setting unit and a determination unit), ROM 12, RAM 13 (one example of a storage unit and a request content storage unit), and NVRAM 14 of nonvolatile memory (one example of a condition setting unit); a network interface 16 (one example of a remote communication unit); a printer port interface 17; a Centronics interface 18, a display unit 19 (first display unit); an operation unit 20 (one example of a command unit and a display selection unit); an execution unit 4 including an image forming unit 110, a scanner unit 120, a modem 130 (one example of a facsimile transmission unit) and an NCU (network control unit) 131; and a bus 6.

The CPU 11 executes computations for implementing various functions of copy, PC print, PC FAX transmission, etc., in the MFP 1 and forms the nucleus of control of the MFP 1. The ROM 12 stores various control programs, various settings, initial values, etc., for controlling the MFP 1. The RAM 13 is used as a work area into which various control programs are read and a storage area for temporarily storing a processing request output from each PC 2. The NVRAM 14 is a storage unit having non-volatility (nonvolatile RAM) for storing various settings, etc.

The network interface 16 transmits a command of the CPU 11 from the MFP 1 to the PC 2 and receives a processing request from the PC 2. In FIG. 2, the MFP 1 is connected from the network interface 16 to the PC 2 through the network 30 of a LAN cable, etc. The invention is not limited to the mode; the printer port interface 17 connected to the PC 2 through a USB (Universal Serial Bus) cable 31 or the Centronics interface 18 connected to the PC 2 through a Centronics line (Centronics is a company name) may be used.

The execution unit 4 for executing a processing request output from each PC 2 includes the image forming unit 110, the scanner unit 120, the modem 130, and the NCU 131. The image forming unit 110 prints image information contained in a processing request and image information of a document read through the scanner unit 120 on a sheet. The image forming unit 110 may form an image electrophotographically or form an image with using an ink jet. The scanner unit 120 reads an image of a document related to the processing request and generates image information of the document.

The NCU 131 and the modem 130 are used at the time of processing requests of PC FAX transmission and reception and FAX transmission and reception. The NCU (network control unit) 131 is connected to a telephone line 32 and detects a call signal and performs predetermined line control required in sending and receiving. The modem 130 transmits and receives image information contained in the processing request and a protocol signal to transmit and receive the image information. Then, the modem 130 demodulates modulated reception image information received from an associated communication terminal connected to the telephone line 32 or modulates image information at the transmitting time.

The bus 6 is electrically connected to the image forming unit 110, the scanner unit 120, the modem 130, and the display unit 19, and the operation unit 20. The CPU 11 controls the components of the MFP 1 through the bus 6 while storing the processing result in the RAM 13 and the NVRAM 14 in accordance with the control program read from the ROM 12.

The PC 2 forming a part of the image processing system 100 has a CPU 21 for executing various types of computation processing, ROM 22 storing a program of start processing (BIOS, etc.,) performed by the CPU 21 when the PC 2 is started and the like, RAM 23 used as a temporary storage area when the CPU 21 performs various types of processing, and a hard disk drive (HDD) 24 storing various programs and data, as shown in FIG. 2.

The PC 2 also has an operation unit 28 (one example of an instruction unit) including a keyboard, a mouse, etc., a display unit 27 (one example of a second display unit) of a liquid crystal display, etc., and a network interface 26 (second reception unit, transmission unit) for transferring a signal to and from the MFP 1 through the network 30.

Connection of the MFP 1 and the PC 2 is not limited to connection through the network interfaces 16 and 26; the MFP 1 and the PC 2 may be connected through the printer port interface 17 and a printer port interface 25.

The image processing system 100 enables the PC 2 to use the MFP 1 through the network 30 or the USB cable 31. That is, the PC 2 can output a processing request of PC print, PC FAX, etc., to the MFP 1 through the network 30 or the USB cable 31.

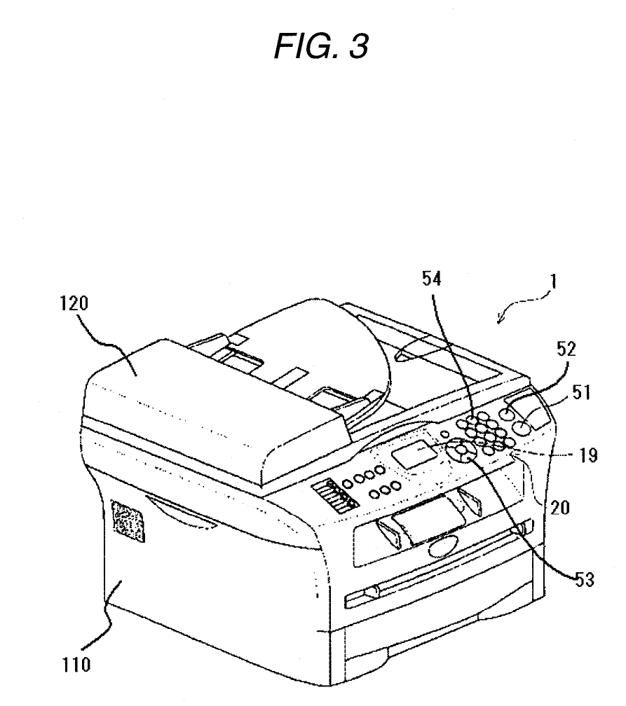

FIG. 3 shows the appearance of the MFP 1. The display unit 19 is positioned at the front of the scanner unit 120 and includes a display unit of a liquid crystal display, etc. The operation unit 20 is positioned at the front of the scanner unit 120 and includes an input unit of a determine button 51, a cancel button 52, a cursor 53, an input unit 54 for allowing the user to enter characters and digits, and the like.

(Transmission Processing of Processing Request from Each PC to MFP)

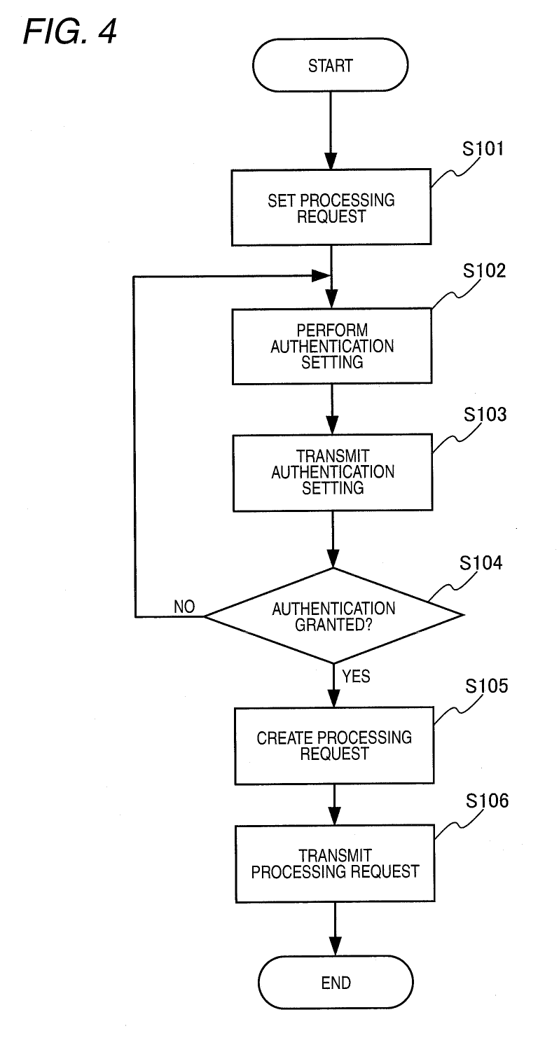

Next, a transmission processing of a processing request from the PC 2 to the MFP 1 will be described with a flowchart of FIG. 4. To begin with, a processing request is set from the PC 2 of the user (S101).

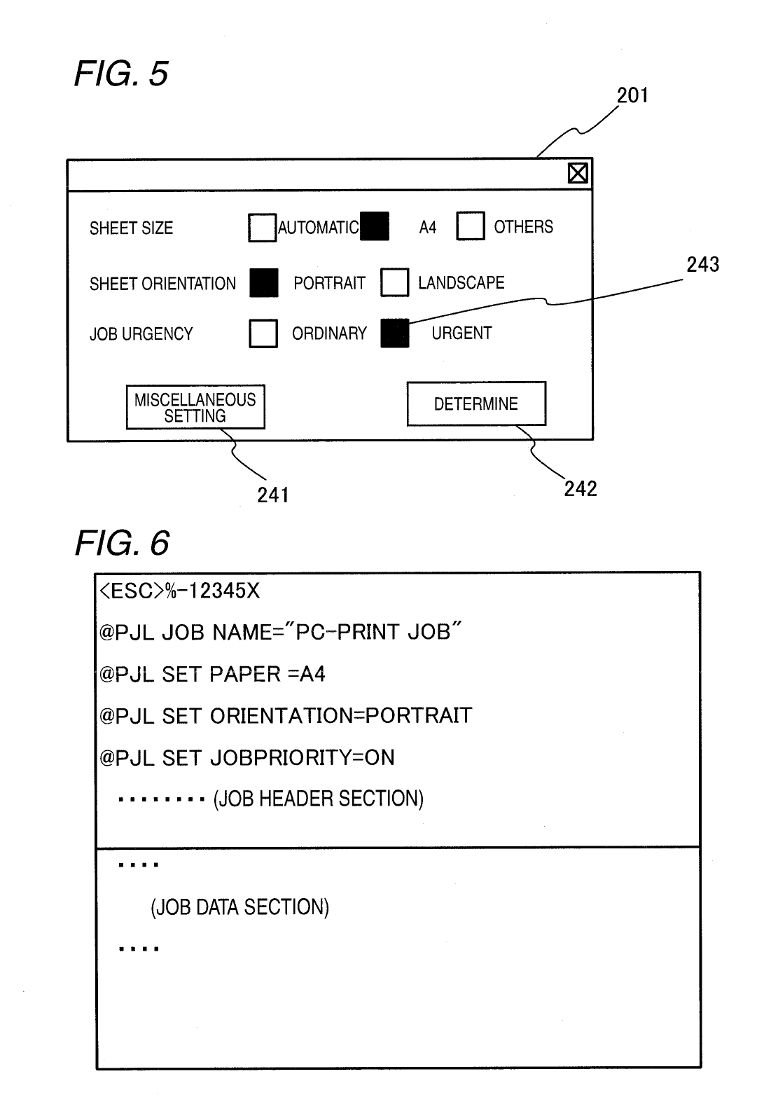

FIG. 5 shows an example of a user interface 201 for setting a processing request from the PC 2. This user interface 201 is displayed on the display unit 27 based on a printer driver installed in the HDD 24. To transmit a processing request of PC print, PC FAX transmission, etc., of image information created with the PC 2 by the user, the user sets the processing request using the user interface 201.

The user interface 201 includes set items of a sheet size of A4, automatic setting, etc., and sheet orientation of portrait or landscape. In the set items, the user can select any selection box using the mouse of the operation unit 28. If the user wants to process a processing request urgently, he or she can select an urgency selection box 243 using the mouse of the operation unit 28.

If the user presses a miscellaneous setting button 241, miscellaneous set items not shown in FIG. 5 are displayed. In the miscellaneous set items, the user can select any processing request of PC print, PC SCAN, PC FAX transmission, etc. In the miscellaneous set items, any processing request can be set in response to the selected processing request; for example, the telephone number if the selected processing request is PC FAX transmission or the number of pages to be printed and the number of copies if the selected processing request is PC print.

The user can determine a determine button 242 in FIG. 5 using the mouse of the operation unit 28. Upon determination, the CPU 21 completes the setting of the processing request at S101 in FIG. 4.

Next, at S102, authentication setting to the MFP 1 is performed. The user cannot execute any processing request using the MFP 1 unless user authentication to the MFP 1 is acknowledged. For the processing, the user enters the user name and the password through the keyboard of the operation unit 28. The PC 2 transmits the user name and the password to the MFP 1 as input authentication identification information (S103).

When the input authentication identification information is transmitted from the PC 2 to the MFP 1, the MFP 1 receives the input authentication identification information transmitted from the PC 2 at the network interface 16. The MFP 1 determines whether or not authentication identification information previously stored in the NVRAM 14 and the received input authentication identification information match. If they match, the MFP 1 transmits authentication grant from the network interface 16.

Next, the CPU 21 determines whether or not the authentication grant from the MFP 1 is received at the network interface 26 (S104). If no authentication grant can be received (S104: NO), the process returns to S102. If the authentication grant is received (S104: YES), the processing request is created in a PJL command (print control language command) in accordance with the processing request setting at S101 (S105). The PJL command is transmitted to the MFP 1 (S106).

FIG. 6 shows an example of the PJL command (print control language command). The setting made at S101 is described in a PJL command format. The processing request “PC-print,” the sheet size “A4,” the sheet orientation “PORTRAIT,” and the processing request urgency “ON (urgent)” are described in a job header section of the PJL command in FIG. 6. The job header section contains various pieces of information of the IP address of the PC transmitting the processing request, the number of pages, an example of the data amount relating to the processing request, the user name, and the like although not shown. A job data section contains data of image information to be printed by PC print.

(Creating Processing Request by MFP)

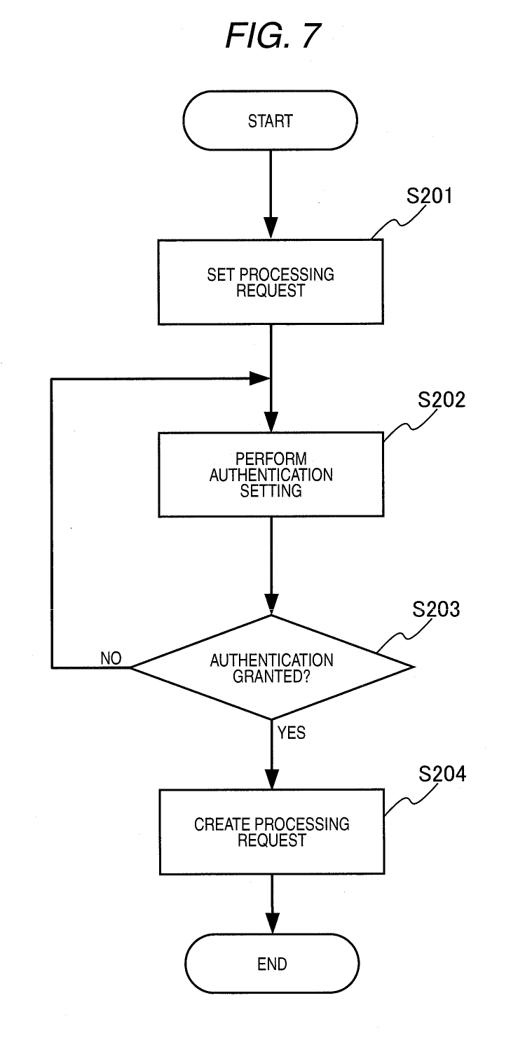

Next, a case where a processing request is created by the MFP 1 without intervention of the PC 2 will be described with a flowchart of FIG. 7. To begin with, the user sets a processing request (S201).

At S201, the display unit 19 displays a content having the same display format as the processing request setting screen 201 in FIG. 5. Set items of a sheet size of A4, automatic setting, etc., and sheet orientation of portrait or landscape are displayed on the display unit 19 as with FIG. 5. The user selects any of the set items using the cursor 53 of the operation unit 20. An urgency selection box (not shown) is also displayed as a set item on the display unit 19 as with FIG. 5 and can be selected by the user using the cursor 53.

Next, at S202, authentication setting of the user to the MFP 1 is performed. For this processing, the user enters the user name and the password using the input unit 54 of the operation unit 20. The MFP 1 stores the user name and the password in the RAM 13 as input authentication identification information.

The MFP 1 determines whether or not the input authentication identification information stored in the RAM 13 and the authentication identification information previously stored in the ROM 12 match (S203). If the input authentication identification information and the authentication identification information match, the MFP 1 creates the processing request in a PJL command (print control language command) in accordance with the processing request setting (S204).

(Processing Request Acceptance Processing in MFP)

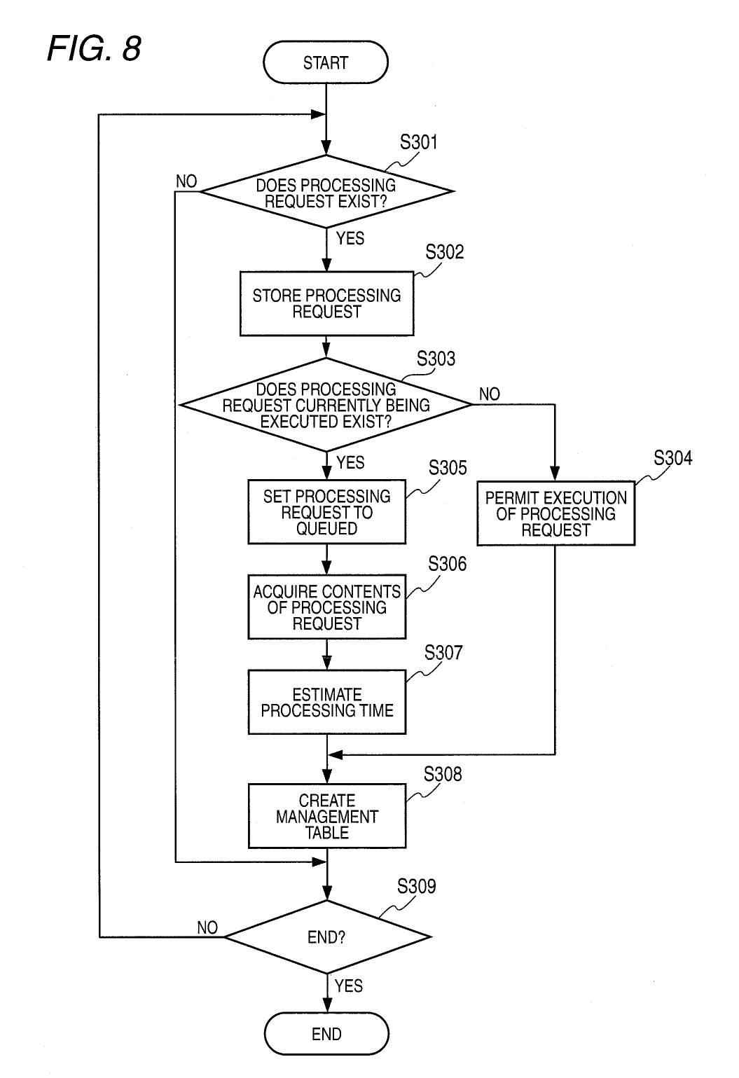

Subsequently, the processing request acceptance processing in the MFP 1 will be described with reference to a flowchart of FIG. 8. The processing request acceptance processing is started just after power of the MFP 1 is turned on. The acceptance processing is continued until the power of the MFP 1 is turned off.

First, whether or not the CPU 11 functioning as an acceptance unit accepts a processing request is determined (S301). When the PC2 transmits a processing request described in a PJL command to the MFP 1 (S106 in FIG. 4), if the CPU 11 receives the processing request through the network interface 16 or if the MFP 1 completes creation of the processing request (S204 in FIG. 7), it is determined that the CPU 11 receives the processing request (S301: YES). The processing request created in the PJL command is stored in the RAM 13 (one example of a storage unit) (S302).

If the CPU 11 does not receive the processing request (S301: NO), the process goes to S309. At S309, if the power of the MFP 1 is turned off (S309: YES), the processing request acceptance processing in the MFP 1 is completed. If the power of the MFP 1 is not off (S309: NO), the process returns to S301 and whether or not the CPU 11 accepts a processing request is determined.

Next, if a processing request executed using the execution unit 4 of the image forming unit 110, etc., does not exist at the current point in time (S303: NO), the CPU 11 functioning as a setting unit sets the accepted processing request as a permitted processing request (S304). The setting is stored in the RAM 13 as status information of “executing.”

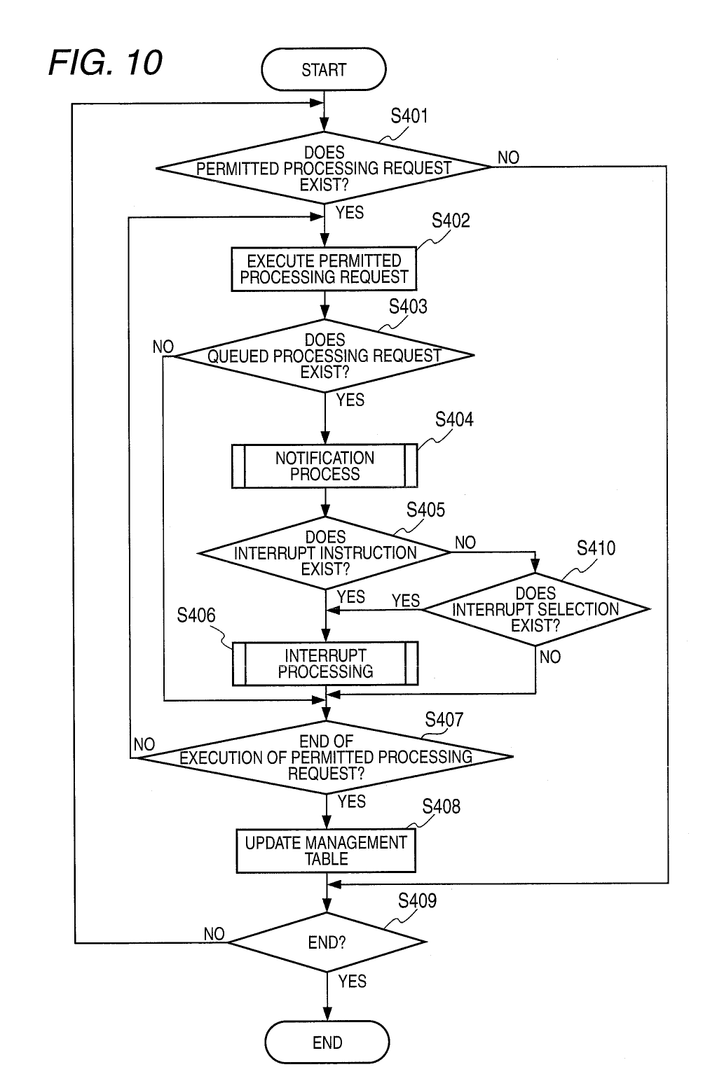

When the accepted processing request is set as a permitted processing request, the permitted processing request is executed by the execution unit 4 in processing request execution processing described later with reference to FIG. 10.

If there is a processing request already being executed using the execution unit 4 (S303: YES), the CPU 11 functioning as the setting unit sets the accepted processing request as a queued processing request (S305). The CPU 11 stores the setting in the RAM 13 as status information of “queued.”

Next, the CPU 11 extracts the user name, the processing request type, information concerning the data amount or the processing time related to the processing request, and information indicating urgency of the processing request from the PJL command stored as the processing request in the RAM 13, thereby acquiring the contents of the queued processing request (S306). The acquired contents of the queued processing request are stored in the RAM 13.

Next, the processing time of the queued processing request is estimated (S307). The average processing time taken in a processing request per sheet such as PC print is stored in the NVRAM 14. The CPU 11 can estimate the processing time of the queued processing request by multiplying the average processing time by the data amount related to the processing request such as the number of pages, stored in the NVRAM 14. The found processing time of the queued processing request is stored in the RAM 13.

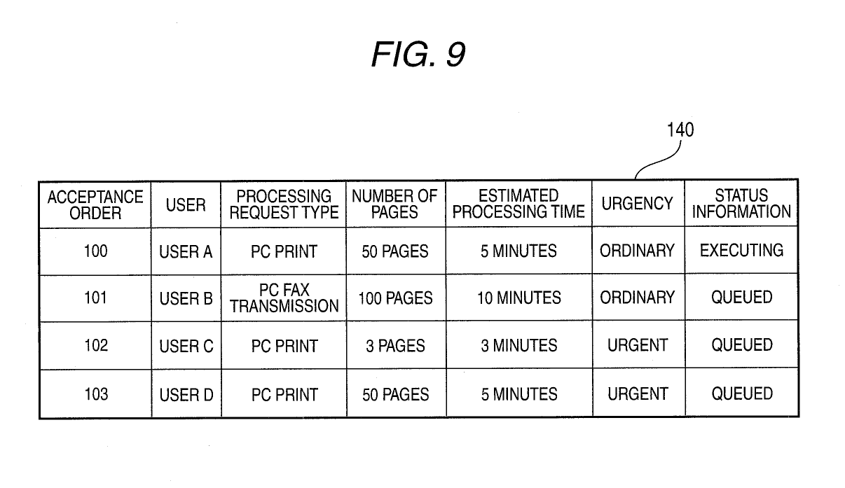

Next, at S308, an example of a management table 140 (one example of a request content storage unit) in the RAM 13 as later described with reference to FIG. 9 is created. A table of the user name, the processing request type, information concerning the data amount or the processing time related to the processing request, information indicating urgency of the processing request, and status information of “executing” or “queued” is stored in the management table 140 in the processing request acceptance order from steps S304, S305, S306, and S307.

When the management table 140 is created at S308, the process goes to S309. The processing request acceptance processing is executed until the power of the MFP 1 is turned off (S309: YES).

(Management Table)

Next, the management table 140 shown in FIG. 9 will be described. The management table shown in FIG. 9 is an example of the management table in the case where the user A using the PC 2A, the user B using the PC 2B, the user C using the PC 2C, and the user D using the PC 2D output a processing request to the MFP 1 in order.

The processing request output by the user A is as follows: The processing request acceptance order of the CPU 11 is 100; the processing request type is “PC print;” the number of pages is “50;” the estimated processing time is “5 minutes;” and the processing request urgency is “ordinary.” The processing request output by the user A is accepted first by the CPU 11 and thus is currently being executed using the execution unit 4 of the MFP 1. Then, the status information indicating the status of the processing request of the user A is stored in the management table 140 as “executing.”

The processing request output by the user B is as follows: The processing request acceptance order of the CPU 11 is 101; the processing request type is “PC FAX transmission;” the number of pages is “100;” the estimated processing time is “10 minutes;” and the processing request urgency is “ordinary.” The processing request output by the user C is as follows: The processing request acceptance order of the CPU 11 is 102; the processing request type is “PC print;” the number of pages is “3;”the estimated processing time is “3 minutes;” and the processing request urgency is “urgent.” The processing request output by the user D is as follows: The processing request acceptance order of the CPU 11 is 103; the processing request type is “PC print;” the number of pages is “50;” the estimated processing time is “5 minutes;” and the processing request urgency is “urgent.”

After accepting the processing request of the user A, the CPU 11 accepts the processing requests of the users B, C, and D. Thus, the status information of each of the processing requests of the users B, C, and D is stored in the management table 140 as “queued.”

The contents related to the above-described processing request of the users are stored in the RAM 13 shown in FIG. 9 as the management table 140. The priority orders of execution of the processing requests of the users B, C, and D become first, second, and third in the processing request acceptance order.

(Processing Request Execution Processing in MFP (1))

The processing request execution processing in the MFP 1 of the characteristic configuration of the invention will be described with a flowchart of FIG. 10. The processing request execution processing in the MFP 1 is executed in parallel independently of the processing request acceptance processing shown in FIG. 8.

To begin with, the CPU 11 determines whether or not a permitted processing request exists based on whether or not the status information of the permitted processing request, “executing,” exists in the management table 140 stored in the RAM 13 (S401).

If no permitted processing request exists in the management table 140 (S401: NO), the process goes to S409. At S409, if the power of the MFP 1 is turned off (5409: YES), the processing request execution processing in the MFP 1 terminates. If the power of the MFP 1 is not turned off (S409: NO), the process returns to S401 and the CPU 11 determines whether or not a permitted processing request exists based on the management table 140.

If a permitted processing request exists in the management table 140 (S401: YES), the permitted processing request is executed using the execution unit 4 (S402).

Next, the CPU 11 determines whether or not a queued processing request exists according to whether or not the status information of the queued processing request, “queued,” exists in the management table 140 stored in the RAM 13 (S403).

If no queued processing request exists in the management table 140 (S403: NO), the process goes to S407. At S407, if the execution unit 4 does not complete execution of the permitted processing request (S407: NO), the process returns to S402 and execution of the permitted processing request is continued.

If the status information of the queued processing request, “queued,” exists in the management table 140 while the execution unit 4 is executing the permitted processing request (S403: YES), the process goes to notification processing at S404.

(Condition Setting Processing)

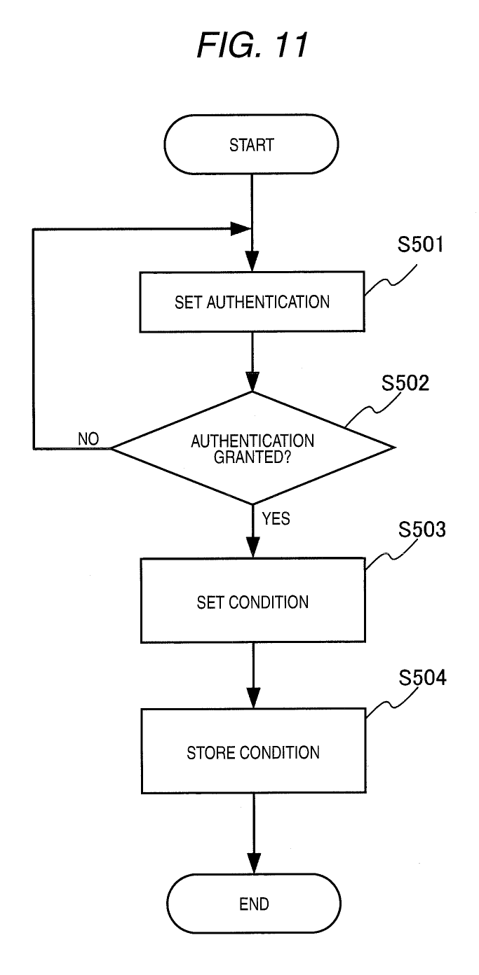

Before the notification processing at S404 in FIG. 10 is described, the condition setting processing for determining whether or not to provide notification that a queued processing request exists will be described with a flowchart of FIG. 11. The condition setting processing is performed independently of the processing request acceptance processing in FIG. 8 and the processing request execution processing in FIG. 10.

To begin with, the user enters the user name and the password through the input unit 54 of one component of the operation unit 20. The entered user name and password are stored in the RAM 13 as input authentication identification information (S501). If the authentication identification information of the user and the input authentication identification information match, the CPU 11 grants authentication (S502: YES). If the authentication identification information of the user and the input authentication identification information do not match (S502: NO), the process returns to S501.

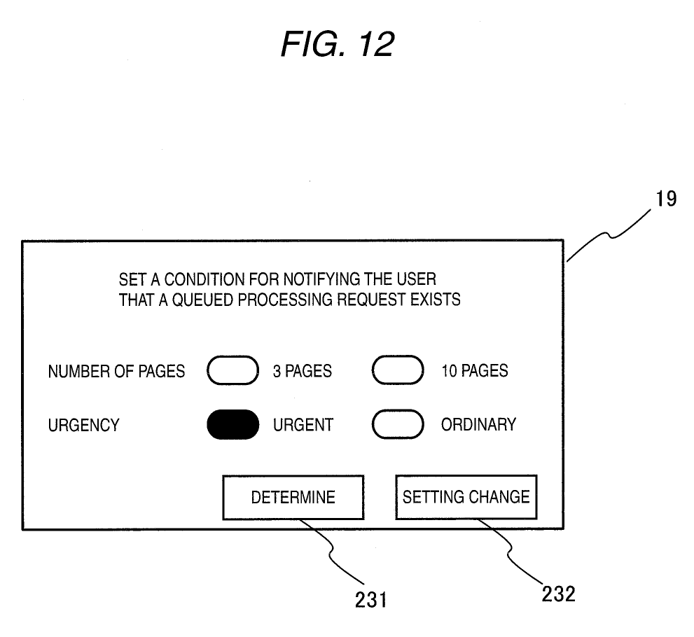

Next, at S503, a condition is set. The condition is set in response to the number of pages of information concerning the queued processing request and the information indicating the urgency of the processing request. The user can set the condition using a condition setting screen shown in FIG. 12 displayed on the display unit 19.

Usually, a processing request of PC print of three sheets or less or 10 sheets or less, etc., is completed at once. Then, the condition setting screen in FIG. 12 enables the user to set the number of pages as “three pages or less” or “ten pages or less” as the condition. The condition setting screen in FIG. 12 also enables the user to select either “ordinary” or “urgent” as the information indicating the urgency of the processing request.

If the user wants to make any other setting than the number of pages or the information indicating the urgency of the processing request as the condition or change the current setting, the user can select a setting change button 232 using the operation unit 20. Incidentally, the number of conditions is not limited, and plural conditions can be set. For example, it is possible to set the conditions such that the number of pages is “three pages or less” and the information indicating the urgency of the processing request is “urgent”.

In the following descriptions, it is assumed that “urgent” is selected as the information indicating the urgency of the processing request of the user A, as the condition for determining whether or not to provide notification that a queued processing request exists.

The user presses a determine button 231. Then, the CPU 11 exits the processing at S503. The condition set on the condition setting screen in FIG. 12 is stored in the NVRAM 14.

In the above-described condition setting processing, the condition is set for each user. However, it may not be necessary to set the condition for each user. The manager of the MFP 1 may preset conditions for all users and each user may use the condition settings. The condition setting processing in FIG. 11 is performed independently of the processing request acceptance processing in FIG. 8. However, in the processing request acceptance processing in FIG. 8, when a processing request is transmitted from each PC 2 to the MFP 1, the condition setting for determining whether or not to provide notification that a queued processing request exists may be transmitted. The condition need not necessarily be set; the user using the MFP 1 may appropriately select and determine.

(Notification Processing)

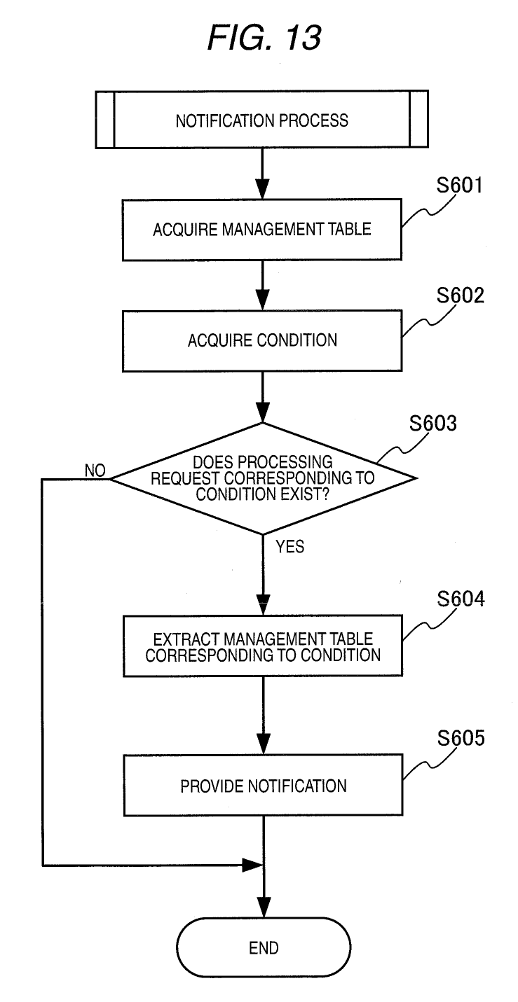

Next, the notification processing for the PC 2 outputting the permitted processing request or the MFP 1 outputting the permitted processing request at S404 in FIG. 10 will be described with a flowchart of FIG. 13.

First, the CPU 11 acquires information in the management table 140 stored in the RAM 13.

Next, at S602, the CPU 11 acquires the condition for determining whether or not to provide notification that a queued processing request exists from the NVRAM 14 storing the condition. The condition is preset for each user by performing the condition setting processing in FIG. 11.

Next, at S603, the CPU 11 determines whether or not a processing request corresponding to the condition exists based on the user's condition of the permitted processing request stored in the NVRAM 14 acquired at S602 and the contents of the management table 140 acquired at S601. For example, assume that the condition is the information indicating the urgency of the processing request is “urgent.” Then, in the management table 140 in FIG. 9, the queued processing requests corresponding to the condition are processing requests of the users C and D.

If the processing request corresponding to the condition exists (S603: YES) as described above, the process goes to S604. The CPU 11 extracts the contents related to the processing request corresponding to the condition (S604). The CPU 11 functioning as a notification unit sends the contents, which are related to the queued processing request corresponding to the extracted condition, to the PC 2 outputting the permitted processing request through the network 16 (S605). If the MFP 1 outputs the permitted processing request, the CPU 11 sends the contents related to the queued processing request corresponding to the extracted condition to the display unit 19 of MFP 1 (S605).

In the example of the management table 140 in FIG. 9, the processing request of the user A is executed by the execution unit 4. That is, the contents related to the queued processing requests of the users C and D are sent to the PC 2A outputting the processing request of the user A.

If the processing request corresponding to the condition does not exist (S603: NO) or if the contents related to the queued processing request corresponding to the extracted condition are sent (S605), the notification processing in FIG. 13 is completed.

Next, instruction processing of an interrupt processing request of each of the PC 2 and the MFP 1 when the contents related to the queued processing request are sent to the PC 2 or the MFP 1 outputting the permitted processing request will be described separately in a first example and a second example.

### First Example

### Instruction Processing of Interrupt Processing Request of PC

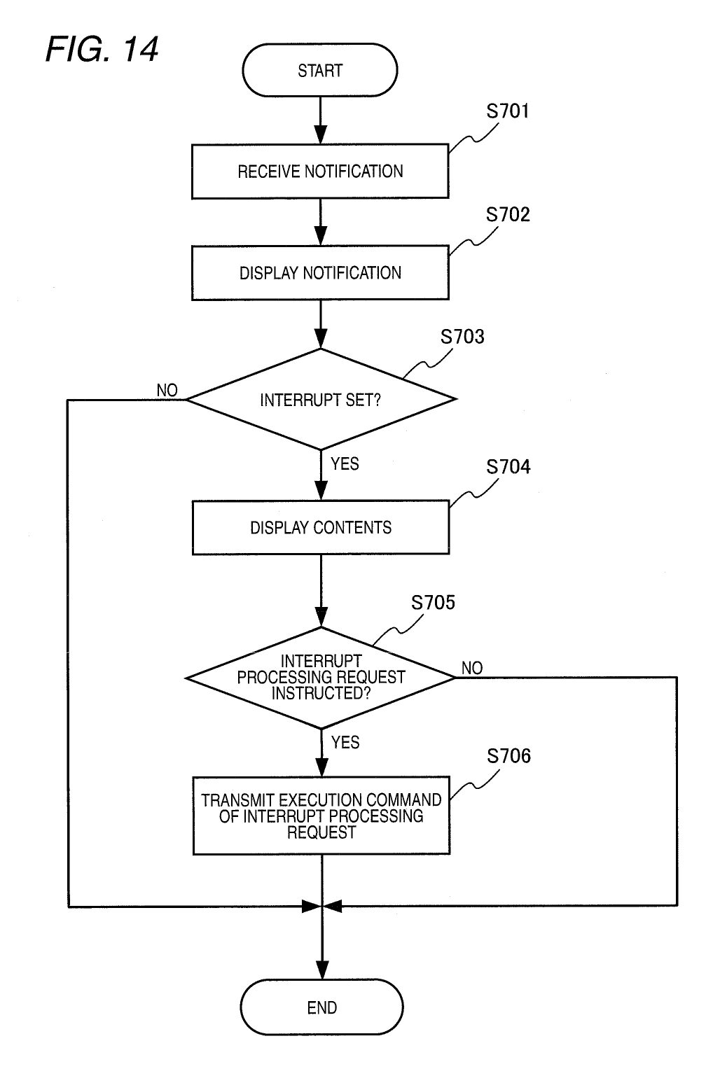

To begin with, the instruction processing of an interrupt processing request of the PC 2 outputting a permitted processing request will be described with a flowchart of FIG. 14. The first example will be described by taking the contents in the management table 140 previously described with reference to FIG. 9 as an example.

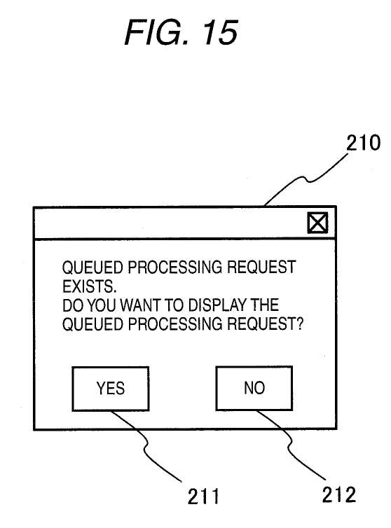

The PC 2 receives the contents related to the queued processing request corresponding to the extracted condition, which is sent from the CPU 11 functioning as the notification unit, through the network interface 26 (one example of a second reception unit) (S701). In the first example, the CPU 11 of the PC 2A receives the contents related to the queued processing request corresponding to the extracted condition. Next, a setting screen (FIG. 15) for selecting whether or not to display the contents related to the queued processing request on the display unit 27 (one example of a second display unit) is displayed on the display unit 27 (S702).

In the first example, to display the contents related to the queued processing request on the display unit 27, the user can press a “YES” button 211 using the operation unit 28 (one example of an instruction unit) of the mouse etc., of the PC 2. The user A can also select suppression of displaying the contents related to the queued processing request on the display unit 27 by pressing a “NO” button 212.

If the user A presses the “NO” button 212 (S703: NO), the instruction processing of an interrupt processing request of the PC 2 terminates. If the user A presses the “YES” button 211 (S703: YES), the process goes to S704. The contents related to the queued processing request corresponding to the extracted condition sent to the PC 2 are displayed on the display unit 27 (S704).

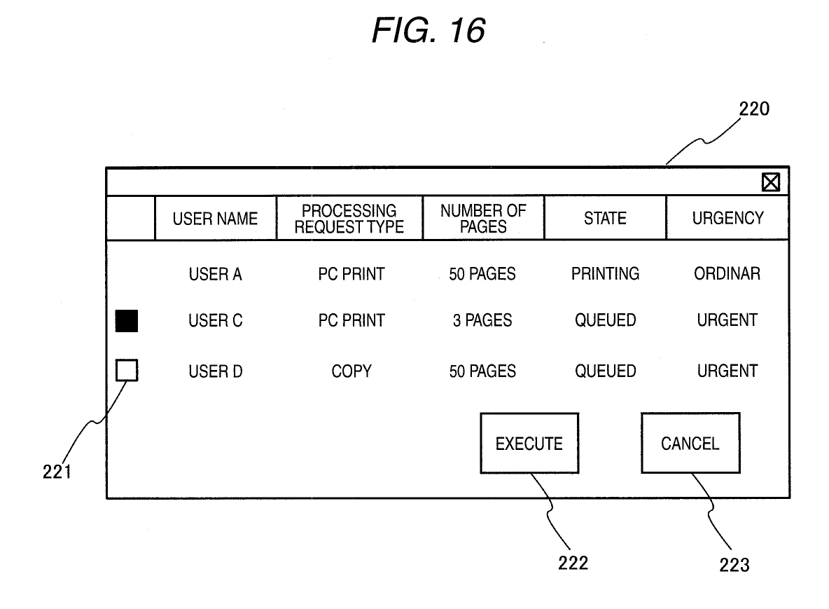

A setting screen in FIG. 16 is displayed on the display unit 27. In the example of the management table 140 in FIG. 9 of the first example, if the condition is set to the urgency of the processing request is “urgent” in the condition processing in FIG. 11, the contents related to the processing requests of the users C and D are displayed on the display unit 27.

In the example of the management table 140 in FIG. 9 of the first example, the user A sees the contents related to the queued processing requests of the users C and D displayed on the display unit 27, interrupts execution of the processing request of the user A, and determines whether or not to allow the queued processing requests of the users C and D to be executed.

For example, the user A makes a comparison between 3 pages of PC print of the user C and 50 pages of PC print of the user D. Then, the user A determines that the processing request of 3 pages of PC print of the user C is smaller than that of 50 pages of PC print of the user A. The user A determines that the queued processing request of the user C may be executed earlier than the permitted processing request of the user A. In such a case, the user A selects a select button 221 corresponding to the user C using the operation unit 28 of the mouse, etc. Then, the user A can instruct that the queued processing request of the user C is an interrupt processing request by pressing an execute button 222.

The user A can not only select one queued processing request, but also select the plurality of queued processing requests. The user can instruct that the plurality of queued processing requests are interrupt processing request by pressing the select button 221 more than once.

If the user A wants to execute his or her permitted processing request taking precedence over any other processing request, the user A can also instruct that any queued processing request is not executed earlier than the permitted processing request of the user A by pressing a cancel button 223.

If the user A presses the execute button 222 (S705: YES), the network interface 26 functioning as a transmission unit transmits a command of interrupt processing request execution to the MFP 1 (S706). The instruction processing of the interrupt processing request of the PC 2 is now completed.

### Second Example

### Management Table

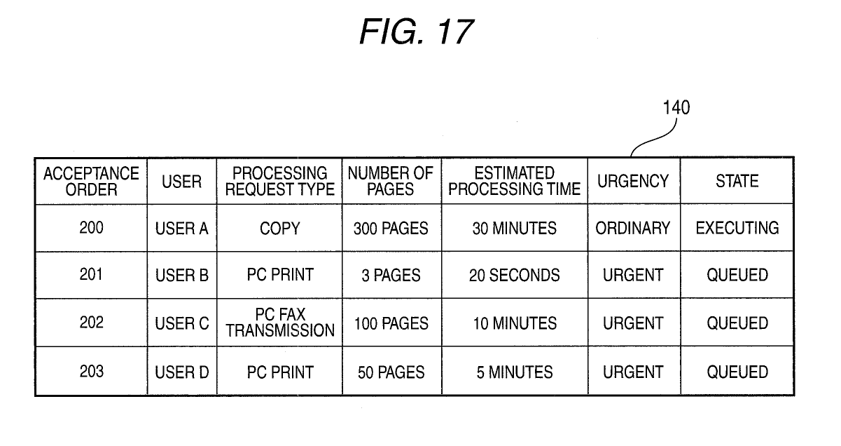

Next, the instruction processing of an interrupt processing request when the MFP 1 outputs a permitted processing request will be described as a second example. A specific example of the second example will be described using a management table 140 in FIG. 17.

In the second example, in the image processing system in FIG. 1, the user A operates the MFP 1 and outputs a processing request. The user B uses the PC 2B to output a processing request; the user C uses the PC 2C to output a processing request; and the user D uses the PC 2D to output a processing request.

It is assumed that the processing request output by the user A is as follows: The order in which the acceptation unit accepts the processing request is 200; the processing request type is “copy;” the number of pages is “300;” the estimated processing time is “30 minutes;” and the urgency of the processing request is “ordinary.” The processing request output by the user A is currently being executed using the execution unit 4. Therefore, the status information is “executing.”

It is assumed that the processing request output by the user B using the PC 2B is as follows: The order in which the acceptation unit accepts the processing request is 201; the processing request type is “PC print;” the number of pages is “3;” the estimated processing time is “20 minutes;” and the urgency of the processing request is “urgent.” It is assumed that the processing request output by the user C using the PC 2C is as follows: The order in which the acceptation unit accepts the processing request is 202; the processing request type is “PC FAX transmission;” the number of pages is “100;” the estimated processing time is “10 minutes;” and the urgency of the processing request is “urgent.” It is assumed that the processing request output by the user D using the PC 2D is as follows: The order in which the acceptation unit accepts the processing request is 203; the processing request type is “PC print;” the number of pages is “50;” the estimated processing time is “5 minutes;” and the urgency of the processing request is “urgent.”

In the second example, since the processing request output by the user A is currently being executed, the status information of each of the processing requests output by the users B, C, and D is “queued.”

The contents of the processing requests of the users mentioned above are stored in the RAM 13 as the management table 140 shown in FIG. 17. Usually, after execution of the processing request of the user A, the priority orders of the processing requests of the users B, C, and D become first, second, and third respectively.

(Instruction Processing of Interrupt Processing Request of MFP)

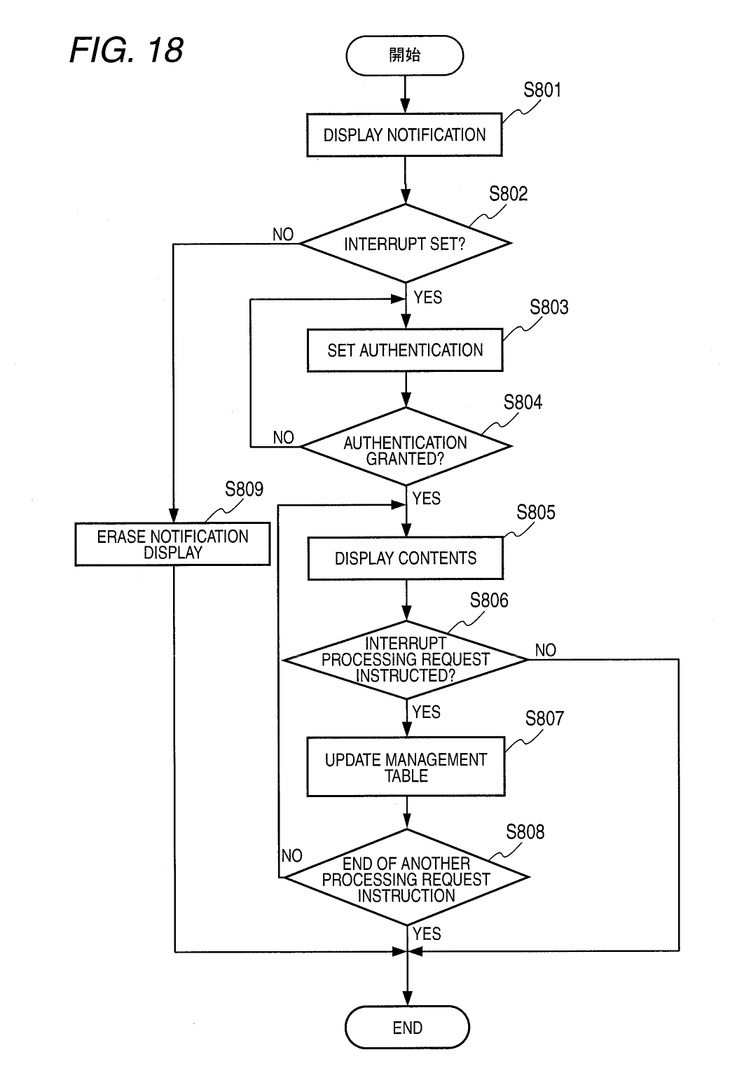

Next, the instruction processing of an interrupt processing request of the MFP 1 outputting a permitted processing request will be described with a flowchart of FIG. 18.

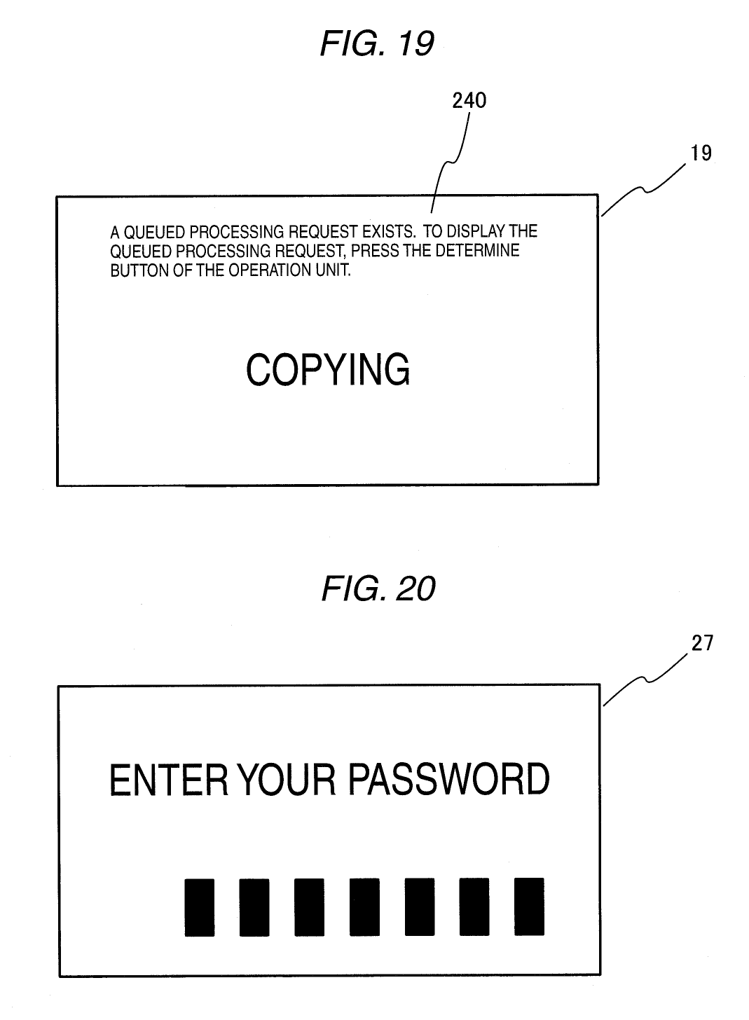

At S605 in FIG. 13, the CPU 11 sends the contents related to the queued processing request corresponding to the extracted condition are sent to the display unit 19 of the MFP 1. Then, a message 240 indicating that a queued processing request exists shown in FIG. 19 is displayed on the display unit 19 (S801).

The display unit 19 displays a character string of “copying” indicating that the processing request of the user A is executed in the second example. The message 240 is “A queued processing request exists. To display the queued processing request, press the determine button of the operation unit.”

Next, the user A can select whether or not to display the contents of the queued processing request in accordance with the message 240. If the user A presses the cancel button 52 (one example of display selection unit) (S802: NO), the message 240 displayed on the display unit 19 is erased (S809).

If the user A presses the determine button 51 (one example of a display selection unit) (S802: YES), the process goes to processing of authentication setting of the user (S803). In this processing, a message of “enter your password” is displayed on the display unit 19 as shown in FIG. 20. The user enters the user name and the password through the input unit 54 of one component of the operation unit 20 in accordance with the displayed message.

The entered user name and password are stored in the RAM 13 as input authentication identification information. If the authentication identification information of the user executing the processing request stored in the ROM 12 and the input authentication identification information match, the CPU 11 grants authentication (S804: YES). If the authentication identification information of the user A and the input authentication identification information do not match (S804: NO), the process returns to the processing of authentication setting of the user at S803.

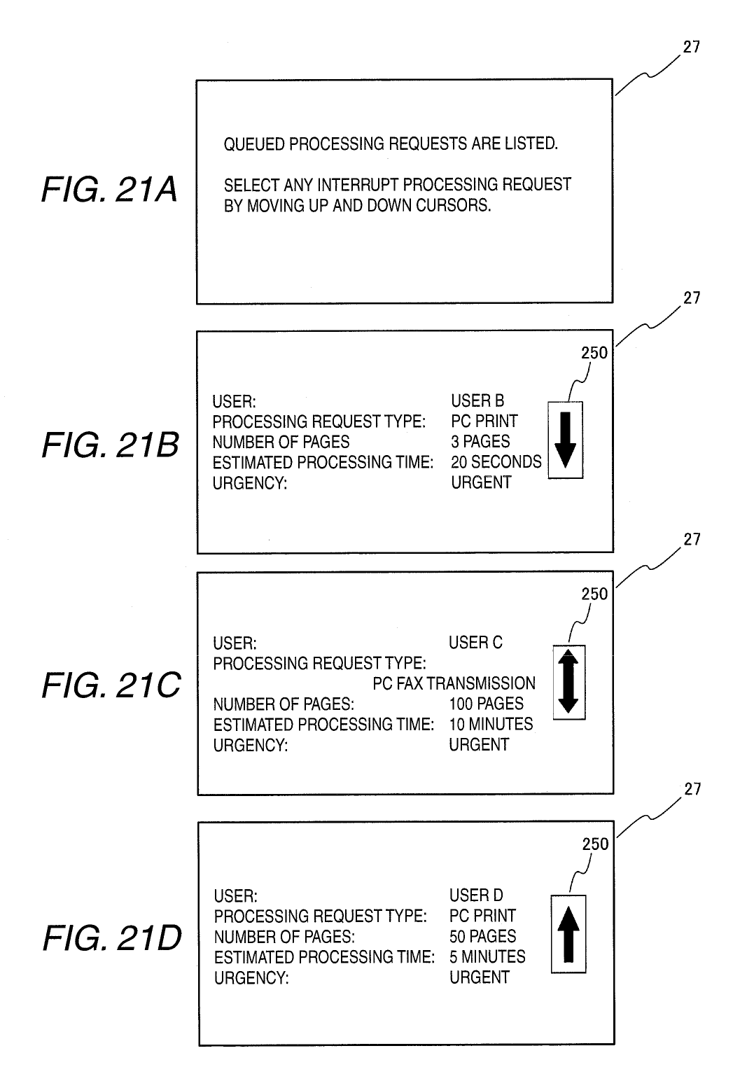

If the CPU 11 grants authentication (S804: YES), a message of listing the queued processing requests is displayed as shown in FIG. 21A. The user operates the cursor key 53 of one component of the operation unit 20 in the direction indicated by a cursor 250, whereby the contents related to the processing requests of the users B, C, and D, the queued processing requests, are displayed on the display unit 27 as in FIGS. 21B, 21C and 21D.

For example, the contents related to the queued processing request of the user

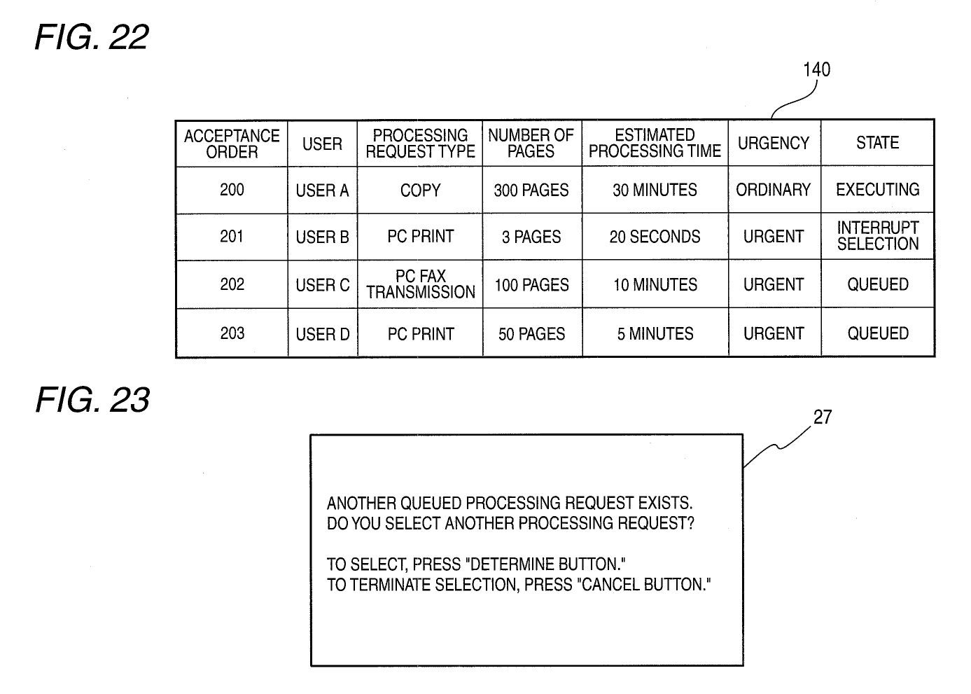

B are displayed on the display unit 19 as in FIG. 21B. At the time, in the second example, the user A presses the determine button 51, whereby the displayed queued processing request can be selected as an interrupt processing request (one example of command unit) (S806: YES). Then, the CPU 11 updates the status information of the processing request of the user B in the management table 140 to “interrupt selection” as in FIG. 22 (S807).

In the second example, the user A can specify no selection of any queued processing request as an interrupt processing request by pressing the cancel button 52. At the time, the CPU 11 assumes that no interrupt processing request is selected, and terminates the processing in FIG. 18 (S806: NO).

Next, in the second example, the user A presses the determine button 51. Then, a message as shown in FIG. 23 is displayed on the display unit 19. If the user A selects another queued processing request, the user can press the determine button 51 (S808: NO). If the user presses the determine button 51, the contents related to the queued processing request are again displayed on the display unit 19 (S805). The user A can again select the queued processing request.

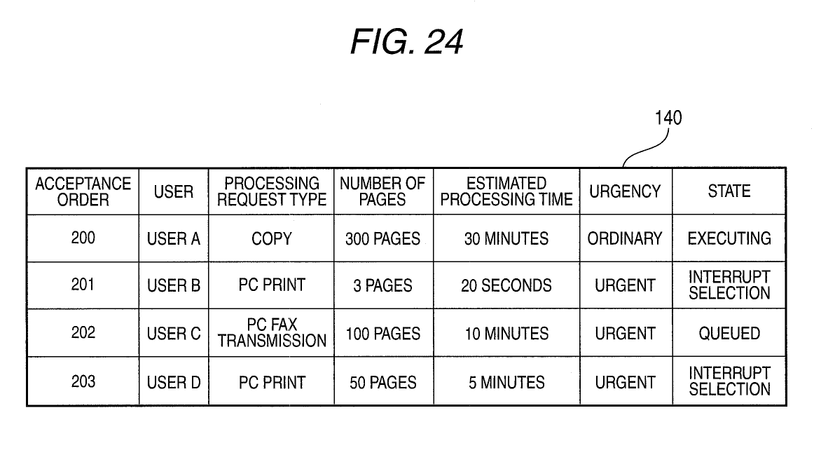

Assume that the contents related to the processing request of the user D in FIG. 21D are displayed on the display unit 19 as the user A again operates the cursor key 53. At the time, the user A presses the determine button 51, whereby the queued processing request can be selected as an interrupt processing request (S806: YES). At this time, the CPU 11 updates the status information of the processing request of the user D in the management table 140 to “interrupt selection” as in FIG. 24 (S807).

If the user A does not select any other queued processing request, he or she presses the cancel button 52. Then, the CPU 11 terminates queued processing request selection (S808: YES).

In the instruction processing of an interrupt processing request of the MFP 1 in the second example described above, if the authentication identification information of the user executing a processing request and the input authentication identification information do not match, the contents related to a queued processing request are not displayed. If the user executing no processing request is permitted to display the contents related to a queued processing request and instruct execution of the interrupt processing request, it is made possible for the user executing no processing request to interrupt the processing request currently being executed by operating the MFP 1. Therefore, by providing the authentication setting processing (S803, S804), only the user of the processing request currently being executed can determine whether or not to display the contents related to a queued processing request.

In the first example, if the authentication identification information of the user and the input authentication identification information do not match, display of the contents related to a queued processing request may be suppressed as in the instruction processing of an interrupt processing request of the MFP 1 in the second example. According thereto, security can be furthermore enhanced.

(Processing Request Execution Processing in MFP (2))

Next, referring again to FIG. 10, the processing request execution processing in the MFP 1 is continued. Whether or not the network interface 16 functioning as a first reception unit receives instruction of execution of interrupt processing request from the PC 2 is determined (S405).

If the network interface 16 functioning as the first reception unit does not receive the instruction of execution of interrupt processing request from the PC 2 (5405: NO), the CPU 11 determines whether or not a queued processing request set to “interrupt selection” in the status information in the management table 140 exists (S410).

If the determination at S405 or S410 is YES, the PC 2 or the MFP 1 instructs an execution of the interrupt processing request, and thus the process goes to interrupt processing (S406). If the determination at S405 or S410 is NO, the PC 2 or the MFP 1 does not instruct the execution of the interrupt processing request, and thus the process goes to S407 and returns to S402 and the execution unit 4 executes permitted processing request.

(Interrupt Processing)

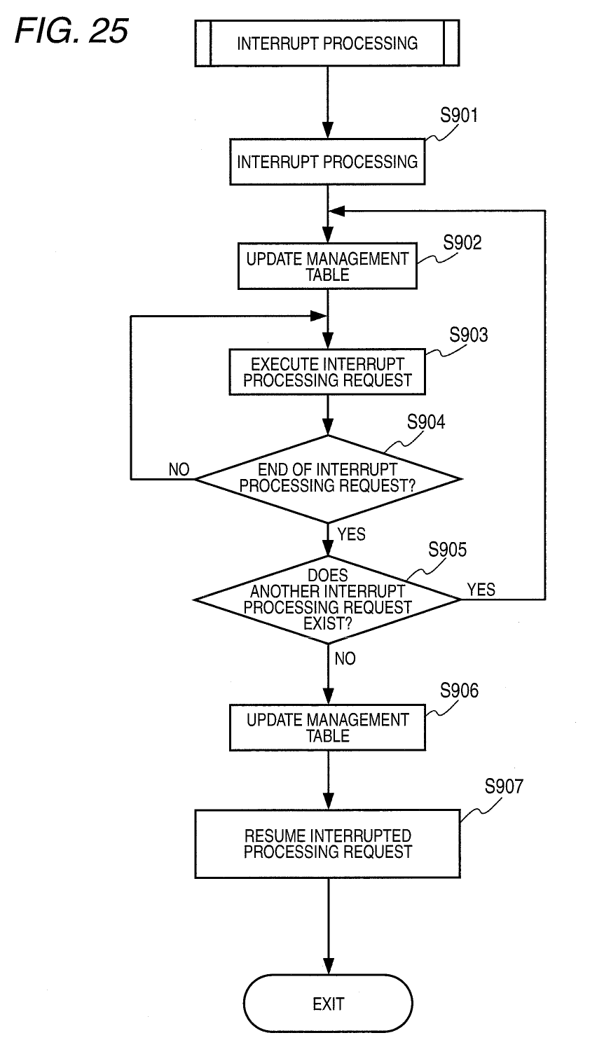

Next, interrupt processing in FIG. 10 (S406) will be described with a flowchart of FIG. 25. To begin with, the CPU 11 functioning as an interrupt control unit interrupts execution of the permitted processing request that is currently being executed (S901). The point at which the processing request is interrupted is stored in the RAM 13. Next, the status information of the processing request stored in the management table 140 is updated (S902).

(Update of Management Table Based on Instruction of Execution of Interrupt Processing Request)

(i) First Example

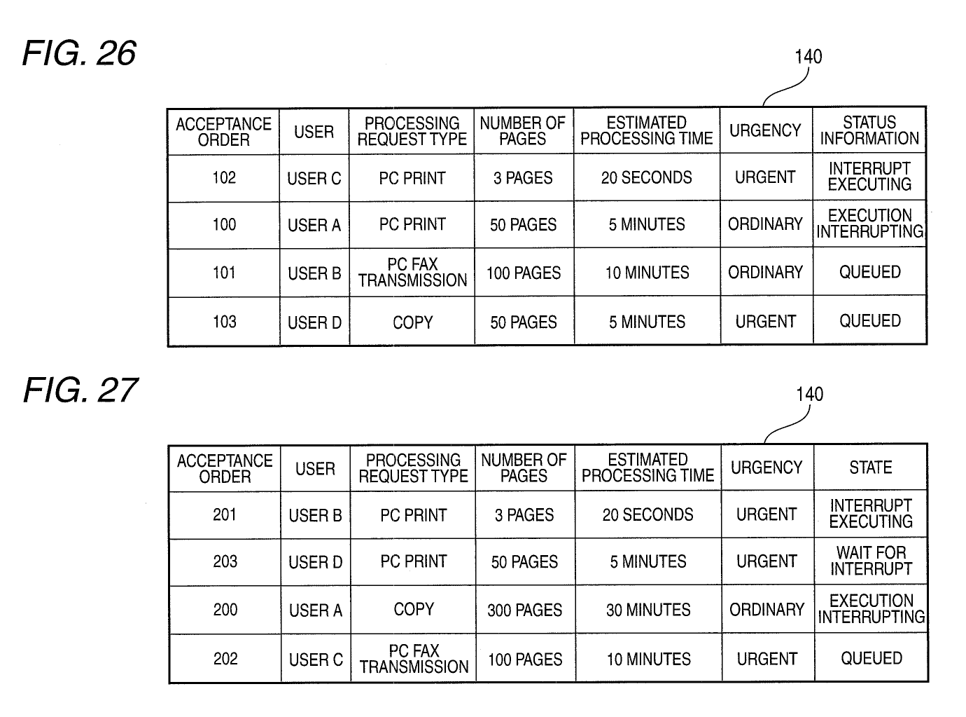

In the first example, the status information of the processing request of the user A in the management table 140 is changed from “executing” to “execution interrupting” for storage as shown in FIG. 26 based on instruction of execution of interrupt processing request from the PC 2A. The status information of the processing request of the user C is changed from “queued” to “interrupt executing” for storage. The processing request execution order is updated as user C, user A, user B, user D.

(ii) Second Example

In the second example, the status information of the processing request of the user A in the management table 140 is changed from “executing” to “execution interrupting” for storage as shown in FIG. 27. The status information of the processing request of the user B is changed from “interrupt selection” to “interrupt executing” for storage and the status information of the processing request of the user D is changed from “interrupt selection” to “wait for interrupt” for storage. The processing request execution order is updated as user B, user D, user A, user C.

Next, the interrupt processing request with the status information in the management table 140 set to “interrupt executing” is executed using the execution unit 4 (S903). In the first example, PC print of the processing request of the user C is executed using the image forming unit 110. In the second example, the processing request of the user B is executed.

Next, when the execution unit 4 completes the interrupt processing request execution (S904: YES), the CUP 11 determines whether or not another interrupt processing request exists (S905).

If the user instructs a plurality of queued processing requests as interrupt processing requests in the MFP 1 at S705 in FIG. 14 or 5806 in FIG. 18, the determination at S905 is YES. The management table 140 is then updated again (S902).

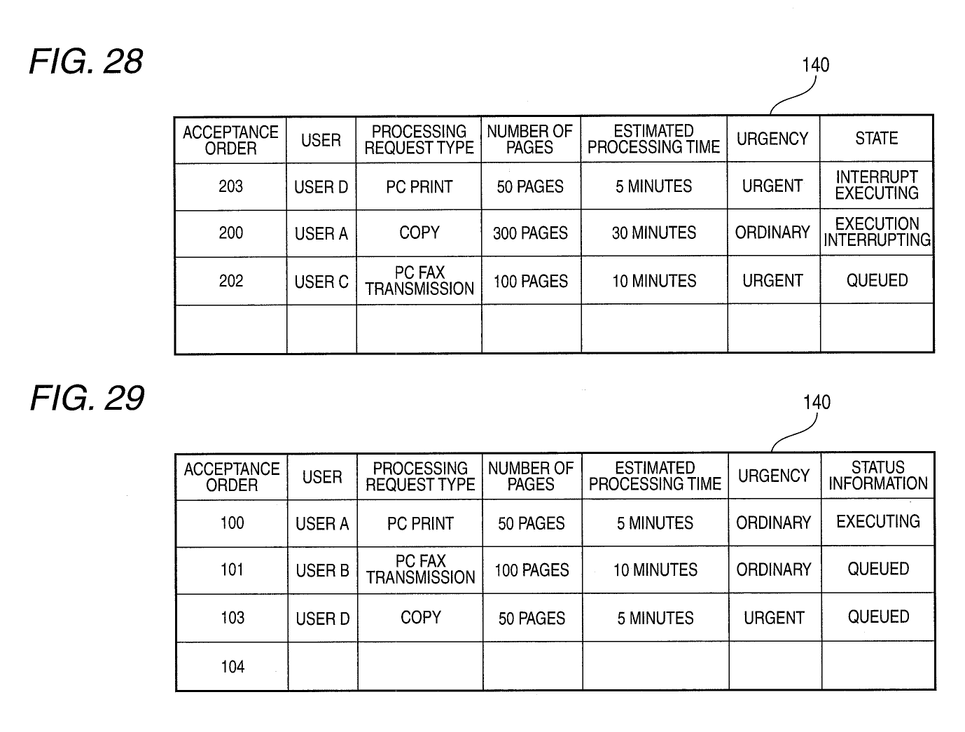

Here, in the second example, since the plurality of interrupt processing requests exists (S905: YES), the process goes to S902. At S902, since the execution of the interrupt processing request of the user B is completed, the entry of the processing request of the user B is deleted from the management table 140 as shown in FIG. 28. The processing request containing image information of the user B is also deleted from the RAM 13. The status information of the processing request of the user D set to “wait for interrupt” is set to “interrupt executing” and is stored in the management table 140.

(Update of Management Table after Completion of Execution of Interrupt Processing Request)

Next, if the number of interrupt processing requests is one as in the first example or if all interrupt processing requests are already completed, the determination at S905 is NO.

Next, the status information of the processing requests stored in the management table 140 is updated (S906). If processing request execution is completed, the processing requests stored in the management table 140 and the RAM 13 are deleted. The status information of the processing request set to “execution interrupting” is changed to “executing” and is stored in the management table 140.

(i) First Example

In the first example, the entry of the processing request of the user C in the management table 140 is deleted as shown in FIG. 29. The processing request containing image information of the user C is also deleted from the RAM 13. The status information of the processing request of the user A set to “execution interrupting” is changed to “executing” and is stored in the management table 140.

(ii) Second Example

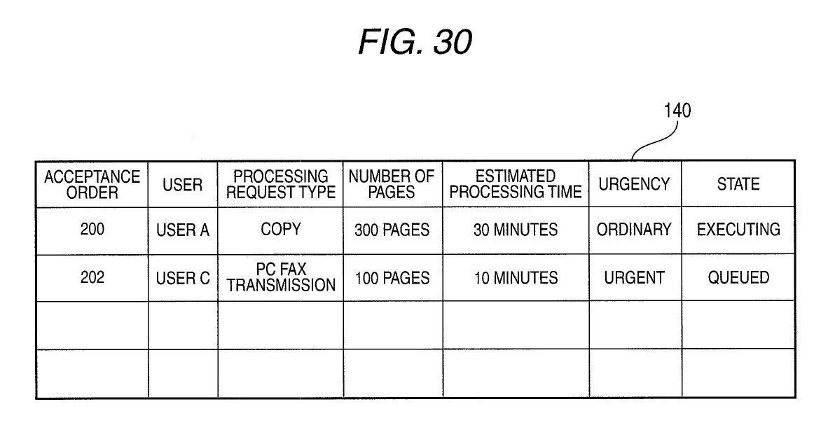

In the second example, the entry of the processing request of the user B in the management table 140 is deleted as shown in FIG. 30. The status information of the processing request of the user A set to “execution interrupting” is changed to “executing” and is stored in the management table 140.

Next, the CPU 11 functioning as a continuation execution unit uses the execution unit 4 to resume the permitted processing request set to “executing” in the management table 140 based on the interrupt information stored in the RAM 13 (S907).

(Processing Request Execution Processing in MFP (3))

Referring again to the flowchart of FIG. 10 relating to the processing request execution processing in the MFP 1, when the execution section 4 completes execution of the permitted processing request (S407: YES), the management table 140 is updated (S408). The status information of the processing request as “queued” in the first acceptance order is set to “executing” in accordance with the acceptance order in the management table 140 and is stored in the management table 140.

The processing request execution processing in the MFP 1 is executed until the power of the MFP 1 is turned off at S409.

While the present invention has been shown and described with reference to certain exemplary embodiments thereof, it will be understood by those skilled in the art that various changes in form and details may be made therein without departing from the scope of the invention as defined by the appended claims.

What is claimed is:

1. An image processing apparatus comprising:
an acceptance unit that accepts a processing request output from a user;
a storage unit that stores the processing request accepted by the acceptance unit;
an execution unit that executes the processing request stored in the storage unit;
a setting unit which, when the processing request is accepted by the acceptance unit, is configured to:
set the processing request stored in the storage unit as a queued processing request if another processing request is executed using the execution unit; and
set the processing request stored in the storage unit as a permitted processing request if no processing request is executed using the execution unit;
a notification unit that notifies a user who outputs the permitted processing request set in the setting unit that there exists a queued processing request set in the setting unit;
an instruction unit which, when instructed by the user whose permitted processing request is being executed based on the notification from the notification unit, instructs whether or not to permit execution of the queued processing request; and
an interrupt control unit which, when the user whose permitted processing request is being executed instructs to permit the execution of the queued processing request through the instruction unit, controls the execution unit to interrupt the execution of the permitted processing request and execute the instructed queued processing request.

2. The image processing apparatus according to claim 1, further comprising:
a request content storage unit that stores the contents related to the queued processing request; and
a first display unit that displays the contents stored in the request content storage unit based on the notification provided by the notification unit,
wherein the instruction unit instructs the instruction from the user whose permitted processing request is being execute whether or not to permit the execution of the queued processing request based on the contents displayed on the first display unit.

3. The image processing apparatus according to claim 2,
wherein the instruction unit selects a plurality of queued processing requests from among the queued processing requests displayed on the first display unit and instructs permission of execution of the selected queued processing requests.

4. The image processing apparatus according to claim 2, further comprising:
a display selection unit that selects whether or not to display the contents stored in the request content storage unit on the first display unit when the notification unit notifies that the queued processing request exists,
wherein, when selected by the display selection unit, the first display unit displays the contents stored in the request content storage unit.

5. The image processing apparatus according to claim 2, further comprising:
a condition setting unit that sets a condition whether nor not to notify the contents related to the queued processing request, the contents including at least one of name of the user, type of the processing request, information concerning the data amount, processing time relating to the processing request and information indicating urgency of the processing request; and
a determination unit that determines whether or not the contents stored in the request content storage unit match the condition set in the condition setting unit,
wherein, if the determination unit determines that the contents stored in the request content storage unit match the condition set in the condition setting unit, the notification unit notifies that there exists the queued processing request matching the condition set in the condition setting unit.

6. The image processing apparatus according to claim 1, further comprising:
a continuation execution unit that controls the execution unit to execute the interrupted processing request after completion of execution of the queued processing request instructed by the interrupt control unit.

7. An image processing system comprising an information processing apparatus for transmitting a processing request and an image processing apparatus for executing the processing request,
wherein the image processing apparatus comprises:
an acceptance unit that accepts the processing request transmitted from the information processing apparatus;
a storage unit that stores the processing request accepted by the acceptance unit;
an execution unit that executes the processing request stored in the storage unit;
a setting unit that is configured to:
set the processing request stored in the storage unit as a queued processing request if another processing request is executed using the execution unit when the processing request is accepted by the acceptance unit; and
set the processing request stored in the storage unit as a permitted processing request if no processing request is executed using the execution unit; and
a notification unit that notifies the information processing apparatus that transmits the permitted processing request set in the setting unit that there exists a queued processing request set in the setting unit,
wherein the information processing apparatus comprises:
a second reception unit that receives the notification from the notification unit;
a second display unit that displays the notification received by the second reception unit;
an instruction unit that instructs whether or not to permit execution of the queued processing request based on the notification displayed on the second display unit; and
a transmission unit that transmits information indicating existence of the queued processing request instructed by the instruction unit to the image processing apparatus, and
wherein the image processing apparatus further comprises:
a first reception unit that receives the information of existence of the instructed queued processing request transmitted by the transmission unit; and
an interrupt control unit which, when the first reception unit receives the information of existence of the instructed queued processing request, controls the execution unit to interrupt the execution of the permitted processing request and execute the instructed queued processing request.

8. A multi-function device comprising:
an image forming unit that forms an image;
a scanner unit that reads the image;
a facsimile transmission unit that transmits/receives facsimile data;
a remote communication unit that is connected to a network;
an input unit that receives input;
a display unit;
a control unit, which is connected to the image forming unit, the scanner unit, the facsimile transmission unit, a remote communication unit, the input unit and the display unit, and which processes a job,
wherein, when the control unit receives a second job through the remote communication unit while the control unit is processing a first job by using one of the image forming unit, the scanner unit and the facsimile unit, the control unit is configured to:
control the display unit to display information indicating receipt of the second job; and
if the input unit receives input, in accordance with the input, execute either one of:
(a) continuing processing the first job while holding processing the second job; or
(b) suspending processing the first job and processing the second job; and
if the input unit does not receive the input, process the first job and the second job in accordance with a received order.

9. A method for controlling a multi-function device, the multi-function device comprising:
an image forming unit that forms an image;
a scanner unit that reads the image;
a facsimile transmission unit that transmits/receives facsimile data;
a remote communication unit that is connected to a network;
an input unit that receives input;
a display unit;
a control unit, which is connected to the image forming unit, the scanner unit, the facsimile transmission unit, a remote communication unit, the input unit and the display unit, and which processes a job,
wherein the method comprises:
control the display unit to display information indicating receipt of the second job; and
if the input unit receives input, in accordance with the input, execute either one of:
(a) continuing processing the first job while holding processing the second job; or
(b) suspending processing the first job and processing the second job; and
if the input unit does not receive the input, process the first job and the second job in accordance with a received order.
